(19) United States
(12) Patent Application Publication
(10) Pub. No.: US 2022/0314479 A1
(43) Pub. Date: Oct. 6, 2022

(54) ULTRAVIOLET SHAVING SYSTEM

(71) Applicant: Midnight Beauty Products, LLC, Bluffdale, UT (US)

(72) Inventors: Kelly E. Thompson, Pleasant Grove, UT (US); Amanda P. Jensen, Pleasant Grove, UT (US); Marc K. Ward, Salt Lake City, UT (US)

(21) Appl. No.: 17/711,699

(22) Filed: Apr. 1, 2022

Related U.S. Application Data
(60) Provisional application No. 63/200,904, filed on Apr. 2, 2021.

(51) Int. Cl. B26B 21/46

(52) U.S. Cl. CPC B26B 21/46

(57) ABSTRACT

An ultraviolet (UV) shaving system can include a fluorescent shaving cream that fluoresces. The fluorescent shaving cream can include at least one fluorescent substance. The fluorescent substance can be configured to bond to hair to cause the hair to glow with fluorescence when exposed to UV light. Additionally, the system can include at least one UV light. In some aspects, the system can include a shaving device that emits the UV light. In some aspects, the shaving device can be a razor, which includes a razor blade and a handle. The handle can include the UV light mounted thereto. The UV light can be located on the handle and oriented to be directed toward the shaving area of the subject being shaved. In some aspects, the UV shaving system includes a UV lighted razor including one or more UV light emitters.

### CROSS-REFERENCE TO RELATED APPLICATIONS

This patent application claims priority to U.S. Provisional Application No. 63/200,904 filed Apr. 2, 2021 which provisional is incorporated herein by specific reference in its entirety.

### BACKGROUND

### Field

The present disclosure relates to a shaving system configured to operate with UV lighting.

### Description of Related Art

During the shaving of various parts of the body using a conventional razor and conventional shaving cream, it can be easy to miss some hair due to the hair being difficult to feel and/or see under normal circumstances. Further, conventional shaving cream typically becomes diluted when it come into contact with water. As a result, unsightly and/or uncomfortable hair may remain after shaving using a conventional razor and conventional shaving cream, resulting in user frustration.

The subject matter claimed herein is not limited to embodiments that solve any disadvantages or that operate only in environments such as those described above; rather, this background is only provided to illustrate one example technology area where some embodiments described herein may be practiced.

### SUMMARY

In some embodiments, an ultraviolet (UV) shaving system is provided. Such a UV shaving system can include a fluorescent shaving cream that fluoresces. The fluorescent shaving cream can include at least one fluorescent substance. The fluorescent substance can be configured to bond to hair to cause the hair to glow with fluorescence when exposed to UV light. Additionally, the system can include at least one UV light. In some aspects, the system can include a shaving device that emits the UV light. In some aspects, the shaving device can be a razor, which includes a razor blade and a handle. The handle can include the UV light mounted thereto. The UV light can be located on the handle and oriented to be directed toward the shaving area of the subject being shaved. In some aspects, the UV shaving system includes a UV lighted razor including one or more UV light emitters.

In some embodiments, a shaving cream that is fluorescent can be provided. The shaving cream can include a fluorescent substance, such as a fluorescent powder mixed into the shaving cream. Additionally, the fluorescent shaving cream can include a bonding agent that is configured to cause the fluorescent substance to adhere to hair more strongly than it adheres to skin.

In some embodiments, a UV emitting shaving device is provided. The UV shaving device can be part of a shaving system that includes replaceable a razor cartridge including one or more blades. The UV emitting shaving device can also include a handle attached to the razor cartridge. The handle can include one or more UV emitters and a power source configured to power the one or more UV emitters to cause the one or more UV emitters to emit UV light.

In some embodiments, a method of shaving with a UV shaving system is provided. Such a method of shaving can include applying a fluorescent shaving cream to an area of skin and hair to be shaved. The fluorescent shaving cream can include a fluorescent substance configured to bond to the hair to cause the hair to glow when exposed to ultraviolet (UV) light.

The shaving method can also include shaving the area of skin and hair with a UV emitting shaving device. The UV shaving device can include one or more UV light emitters emitting UV light.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1 illustrates an embodiment of an ultraviolet (UV) light emitting shaving device.

FIG. 2 illustrates an embodiment of an ultraviolet (UV) light emitting straight razor.

FIG. 3 illustrates an embodiment of an ultraviolet (UV) light emitting electric shaving device.

FIGS. 4A-4B illustrate different view of an embodiment of an ultraviolet (UV) light emitting shaving device.

FIGS. 5A-5B illustrate different embodiments of ultraviolet (UV) light emitting shaving devices.

FIGS. 6A-6C illustrate different embodiments of electronic components for a UV shaving device.

The elements and components in the figures can be arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the present technology relates to an ultraviolet (UV) shaving system. In some embodiments, a UV shaving system may include fluorescent shaving cream and a UV shaving device, which emits UV light. The shaving device can be a UV light emitting razor that includes one more razor blades in a cartridge that is either fixed to a UV light emitting handle or configured to be replaceably coupled with the handle (e.g., disposable razor cartridges). The fluorescent shaving cream may include a fluorescent substance configured to bond to hair to cause the hair to glow when exposed to ultraviolet (UV) light. The UV lighted razor may include one or more UV light emitters.

In some embodiments, the present UV shaving system is an improvement in shaving over traditional shaving with a conventional razor and conventional shaving cream. As a result of the present UV shaving system, a person that is shaving can avoid frustration due to some hair being missed due to the hair being difficult to feel and/or see under normal circumstances, and/or due to conventional shaving cream becoming diluted when it comes into contact with water. Now, the UV system uses the fluorescent shaving cream to make the hairs fluorescent under UV light, which are easier to see and which results in fewer missed hairs, if any hairs are missed. The UV illuminated fluorescent coated hairs are easy to see and can be easily shaven off. Therefore, there can be less frustration in shaving and improved shaving by missing fewer hairs.

Some embodiments include a shaving system. In some embodiments, the shaving system may include fluorescent shaving cream and UV lighted razor, which may work together to provide a smooth and thorough shave that minimizes or eliminates missed hair. In particular, when the fluorescent shaving cream comes into contact with hair, and when the UV light from the UV lighted razor is directed toward the hair, the hair will glow fluorescently, making the hair easier to see while shaving. Accordingly, since a user is less likely to miss fluorescently glowing hair while shaving, some embodiments may minimize or eliminate missed hair, and thereby also minimize or eliminate user frustration.

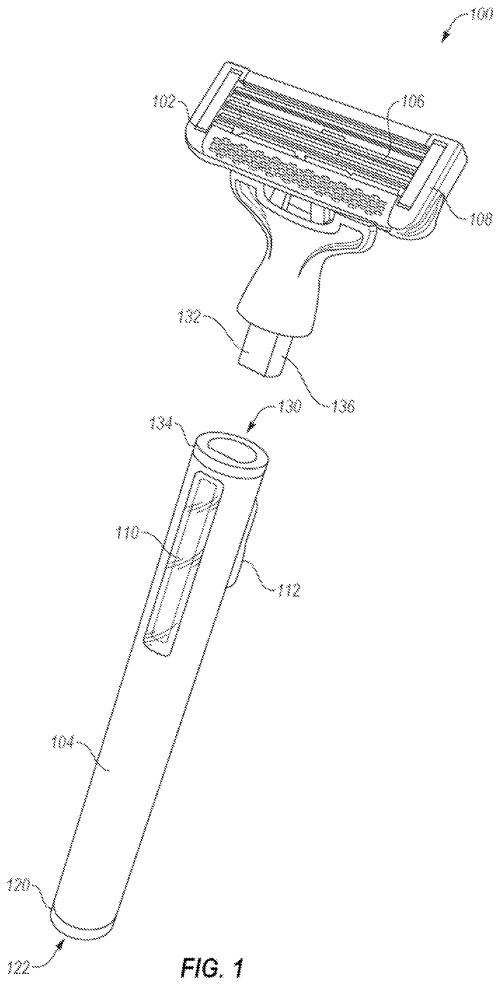

Turning to the figures, FIG. 1 illustrates an example UV lighted razor 100. As disclosed in FIG. 1, the UV lighted razor 100 may include a razor cartridge 102 and a handle 104. In some embodiments, the razor cartridge 102 may be removable so that when one or more blades 106 in a housing 108 of the razor cartridge 102 become dull, the worn razor cartridge 102 can be replaced with a new razor cartridge 102 on the handle 104. The handle 104 may also include one or more UV emitters 110. In some embodiments, the UV emitter 110 can be a high density UV light. The high density UV light may include one or more UV LEDs, which can be arranged in different configurations. As shown, the UV emitter 110 can include a high intensity light bar. In some aspects, the high intensity light bar can include a plurality of individual UV LEDs. In an example, the UV light emitter may include up to seven UV emitting LED diodes 110a.

The UV emitter 110 may be positioned on the handle 104 in order to emit UV light over and around a portion of a user's skin that is being shaved. For example, the UV emitter 110 may be configured to emit UV light over a surface measuring up to about 20 cm×25 cm (e.g., 8″×10″) of illuminated surface or as small as about 10 cm×12.5 cm (e.g., 4″ by 5″) of illuminated surface, or 25 cm diameter of an illuminated circle down to 10 cm, or a surface having some other dimension or some other shape.

The handle 104 may also include a power switch 112 (e.g., on/off switch) to turn the UV emitter 110 on and/or off. In order to power the UV light emitter 110, the handle may also include a power source, such as an internal battery (not shown), which is internal to the handle 104. The internal battery may be disposable, and thereby the handle 104 can include a lid 120 or opening in the handle 104 to remove the old battery and replace it with a new battery. Alternatively, the battery may be rechargeable and the lid 120 can protect the charging port 122. Where the internal battery is rechargeable, the handle 104 may include a charging port 122, such as on the bottom of the handle 106. The charging port 122 may enable the handle 106 to mate with a charging base or charging cable in order to recharge the battery. For example, as disclosed in FIG. 1, the charging port 122 may be configured to mate with a post of a charging base, with the charging base plugged into an electrical outlet on a wall, such that placing the handle 104 on the charging base automatically results in the recharging of the internal battery. This recharging may occur due to electrical contacts of the charging port 122 directly mating between the charging port 122 and the charging base. Alternatively, the handle 104 can be configured for wireless charging to be employed without electrical contacts directly mating.

The UV emitter 110, the power source (e.g., battery), and the charging port 122 may be waterproof so that the UV lighted razor 100 can be used safely in and around tubs and showers without any risk of electrocution to a user or damage to the UV lighted razor 100. The UV lighted razor 100 may be configured to be used with conventional shaving cream, or may be configured to be used with fluorescent shaving cream.

The handle 104 can also include a first coupling member 130 on an end, which coupling member 130 is adapted to couple with the razor cartridge 102. The razor cartridge 102 can include a second coupling member 132, which is configured to couple with the first coupling member 130 when the handle 104 is coupled with the razor cartridge 102. As shown, the first coupling member 130 is a female coupler and the second coupling member 132 is a male coupler; however, this orientation can be switched with the female coupler on the razor cartridge 102 and the male coupler on the handle 104. Also, the handle 104 is shown to include a first magnetic member 134 and the razor cartridge 102 includes a second magnetic member 136, where the first magnetic member 134 magnetically couples the second magnetic member 136. As such, one of the first magnetic member 134 and second magnetic member 136 is a magnet and the other is a magnetically responsive material (e.g., iron, steel, etc.).

In some embodiments, a shaving cream contains a fluorescent powder along with a bonding agent to help it adhere to the hair follicles preferentially over skin. This allows the hair to light up when exposed to black light or UV light. The fluorescent powder can bonded to a positively charged molecule in the shaving cream. Hair is naturally negatively charged, so only the fluorescent powder should bond only to the hair, and not the skin. Thus, creating a unique shaving experience.

In some embodiments, fluorescent shaving cream may include a fluorescent substance (e.g., a fluorescent powder) along with a bonding agent to help it adhere to hair more strongly than it adheres to skin. Then, when used during shaving, this may allow the hair to light up (e.g., glow fluorescently) when exposed to UV light, such as the UV light from the UV lighted razor or UV light from another UV light source. In some aspects, the fluorescent powder is bonded to a positively charged molecule in the fluorescent shaving cream, and because hair is naturally negatively charged, the fluorescent powder may tend to bond more strongly to the user's hair than to the user's skin.

In some embodiments, the bonding agent that bonds the fluorescent substance with the hair can be a cationic substance. Hair is naturally negatively charged. As such, a cationic substance can be coated on the fluorescent particles, which can provide a cationic characteristic to the fluorescent particles. The cationic fluorescent particles can then bond to the hair. Examples of cationic substance can include quaternary cationic surfactants and cationic polymers. Quaternary cationic surfactants include ingredients such as Behentrimonium chloride, Behentrimonium methosulfate, Cetrimonium bromide, Cetrimonium chloride, Stearalkonium chloride, Dicetyldimonium chloride, Guar hydroxypropyltrimonium chloride. Cationic polymers include polyquaterniums (Polyquaternium-4, Polyquaternium-10, for example).

The fluorescent substance can be any type of fluorescent material that can be used as described herein, which can be a powder or particles when dry. The color can be any fluorescent color. Yellow and bright green colors can be especially useful. The fluorescent substance may be a particle, such as a polystyrene particle, impregnated with the fluorescent substance.

The fluorescent substance can include a particle having the fluorescent material therein. The particle can include a core and having at least one shell, such as a lipid shell. The lipid shell can include one or more lipid layers or lipid bilayers. The core can be a fluorescent particle of a fluorescent material, or the core can be aluminum hydroxide with the fluorescent material as part of the core or in one of the layers. For example, each fluorescent particle can include one or more fluorescent materials, which can be in the core and/or one or more of the lipid shells. The shells can be from 1 to 1000 surfactant bi-layers, which can be configured to be hydrodispersable or lipodispersable. The particles can include cationic polymers or cationic surfactants to give the positive charge that attracts to the negatively charged hair. For example, the positively charged cations can be guar hydroxypropyltrimonium, or some other cationic compound. Any fluorescent powder described herein can be the fluorescent particles with the cationic polymer and overall positive charge as described. The particles can be up to 10 mm, or up to 5 mm, or up to 2 mm, or up to 1 mm, or up to 0.75 mm, or up to 0.5 mm, or up to 0.25 mm, or up to 0.1 mm, or as small as 50 microns, or within any range between these recited values. In some aspects, the particles can be up to 1 mm, or up to 500 microns, or up to 200 microns, or up to 100 microns, or up to 75 microns, or up to 50 mm, or up to 25 microns, or up to 10 microns, or as small as 0.50 microns, or within any range between these recited values.

In some embodiments, the fluorescent shaving cream may include one or more elements of the following formulation: 8.2% stearic acid (e.g., soap making agent); 3.7% triethanolamine (e.g., soap-surface-acting agent); 5% lanolin; 6% polyoxyethylene and sorbitan monostearates (e.g., emulsifiers); 2% glycerin (e.g., solvent and emollient, which makes skin soft); 4% phosphoresce powder; and the balance % water (all weight percent). In this formulation, stearic acid may function similar to soap, while triethanolamine may act a surfactant or a surface-acting agent that acts similar to soap. Also, in this formulation, while one end of a surfactant molecule may attract dirt and grease, the other end may attract water. Also, in this formulation, lanolin and polyoxyethylene sorbitan monostearate may both be emulsifiers which hold water to the skin, while glycerin, a solvent and an emollient, may render skin softer and more supple. The phosphorescence powder may or may not have a bonding agent coated thereon. It should be recognized that any of the ingredients or ingredient types (e.g., surfactant, colorant, binder, fluorescent agent) can vary, such as from 1% to 25%, 5% to 20%, or 10%-15% by weight percent.

Alternatively, in some embodiments, fluorescent shaving cream may include one or more elements of the following formulation: Water, Stearic Acid, Sodium Cocoyl Isethionate, Glycerin, Caprylic/Capric Triglyceride, Sodium Methyl Cocoyl Taurate, Hydroxypropyl Bis-Hydroxyethyldimonium Chloride (e.g., bonding agent), Cetearyl Methicone, Hydroxypropyl Guar, Sodium Hydroxide, Propylene Glycol Alginate, Phenoxyethanol, Caprylyl Glycol, Citric Acid, PEG-90M, Ethylhexylglycerin, Hexylene Glycol, Fragrance, Bis(glycidoxyphenyl)propane/Bisaminomethylnorbornane Copolymer, Fluorescent Brightener 230, and Aluminum Hydroxide.

In some embodiments, the color of the fluorescent substance may not be visible to the human eye, which may result in the fluorescent shaving cream initially appearing similar to, and appear to act similar to, any other shaving cream. However, once a user switches on a UV light, the fluorescent substance in the fluorescent shaving cream will cause the hair to glow fluorescently. Seeing these glowing hairs, a user may be better able to then see and more accurately remove more unwanted hairs. Compared to conventional shaving creams, the illuminating property of the fluorescent shaving cream may be less diluted by water, thereby enabling the user to apply the fluorescent shaving cream to an area, and even if that area is then flushed with water, the hair will continue to glow fluorescently while the UV light is shown near the hair even though some or all of the fluorescent shaving cream appears to have washed away from the skin and hair.

In some embodiments, the shaving cream may contain approximately 8.2 weight percent stearic acid, 3.7 weight percent triethanolamine, 5 weight percent lanolin, 2 weight percent glycerin, 6 weight percent polyoxyethylene sorbitan monostearate, and 71.1 weight percent water, and with 4 weight percent fluorescent material. In some aspects, there can be up to 10 weight percent fluorescent material (with a corresponding reduction in any one or more of the other ingredients). Two major ingredients in this formula are common in many of today's preparations. Stearic acid can be an ingredients in soap making, and triethanolamine can be a surfactant, or surface-acting agent. While one end of a surfactant molecule attracts dirt and grease, the other end attracts water. Lanolin and polyoxyethylene sorbitan monostearate are both emulsifiers which hold water to the skin, while glycerin, a solvent and an emollient, renders skin softer and more supple.

In some embodiments, although the UV lighted razor 100 is disclosed in FIG. 1 as a safety razor, any other type of razor can instead be employed to include the UV emitter 110. For example, the UV shaving device can be configured as a UV lighted straight razor, a UV lighted electric razor, or any other UV shaving device.

In some embodiments, although the razor cartridge 102 of the UV lighted razor 110 is disclosed in FIG. 1 as being disposable, the entire UV lighted razor 100 may be disposable. Also, the UV emitter 110 may include one or more discrete light emitting diodes, such as UV LEDs.

In some embodiments, although the UV emitters are disclosed in FIG. 1 as being included in the handle 104 of the UV lighted razor 100, the UV emitter 110 may be included in the razor cartridge 102 or any other portion of the UV lighted razor 100, or other type of UV lighted razor, such as a UV lighted straight razor or a UV lighted electric razor.

In some embodiments, although a particular formulation of the fluorescent shaving cream is provided herein, any other formulation of fluorescent shaving cream, or other fluorescent cream or fluorescent lotion or fluorescent powder or fluorescent oil, may instead be employed. Further, although the fluorescent shaving cream is disclosed herein as being used with a UV lighted razor, any other UV light may instead be employed in connection with a conventional razor.

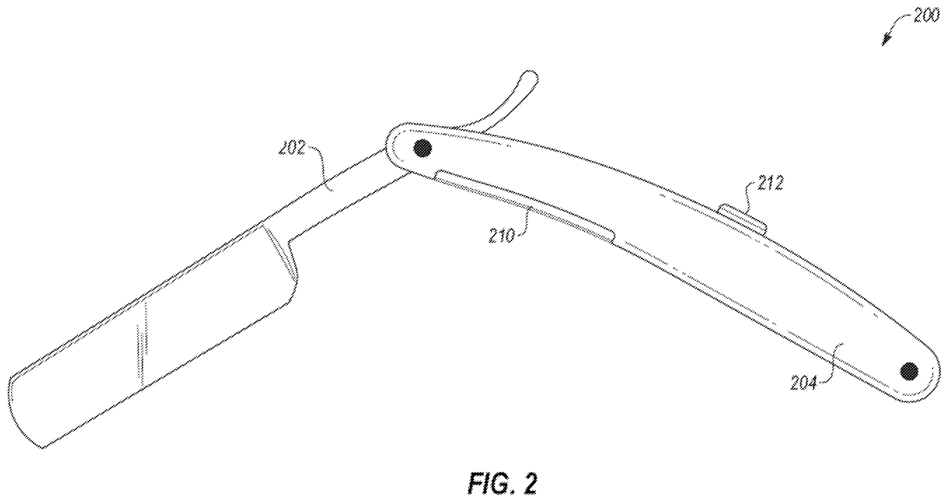

FIG. 2 illustrates a straight razor 200 with a blade 202 pivotally coupled to a handle 204 that includes a UV emitter 210 and a power switch 212. The straight razor 200 with UV emitter 210 can be used for shaving with fluorescent shaving cream as described herein.

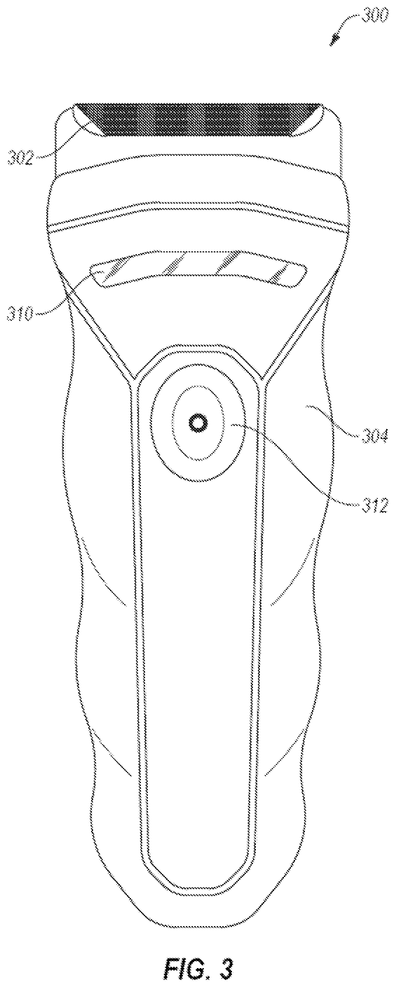

FIG. 3 illustrates an electric shaver 300 with a shaving blade assembly 302 coupled to a handle 304 that includes a UV emitter 310 and a power switch 312. The electric shaver 300 with UV emitter 310 can be used for shaving with fluorescent shaving cream as described herein.

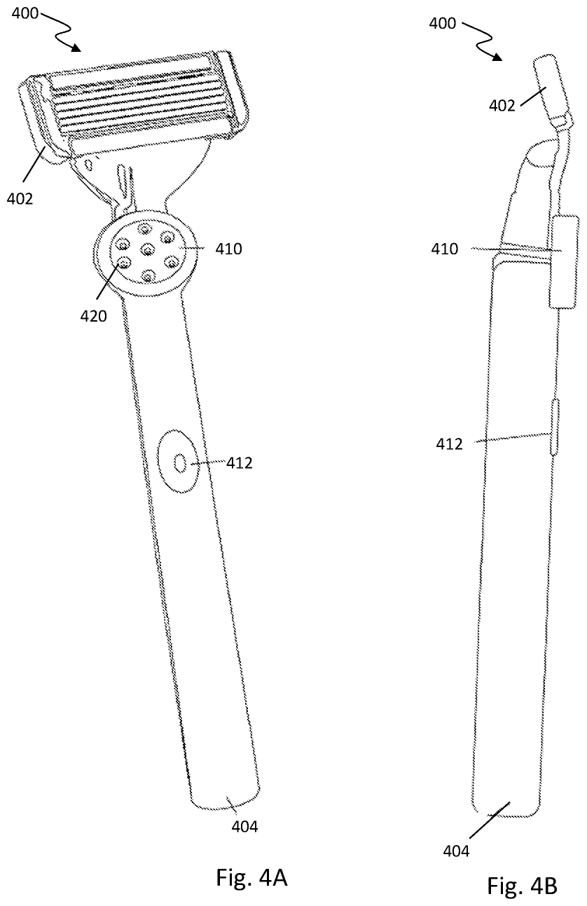

FIGS. 4A and 4B illustrate a perspective view and a side view, respectively, of a UV shaving device 400 with a blade cartridge 402 coupled to a handle 404 that includes a UV emitter 410 and a power switch 412. Additionally, the UV emitter 410 can include a plurality of individual UV LEDs 420 that emit UV light.

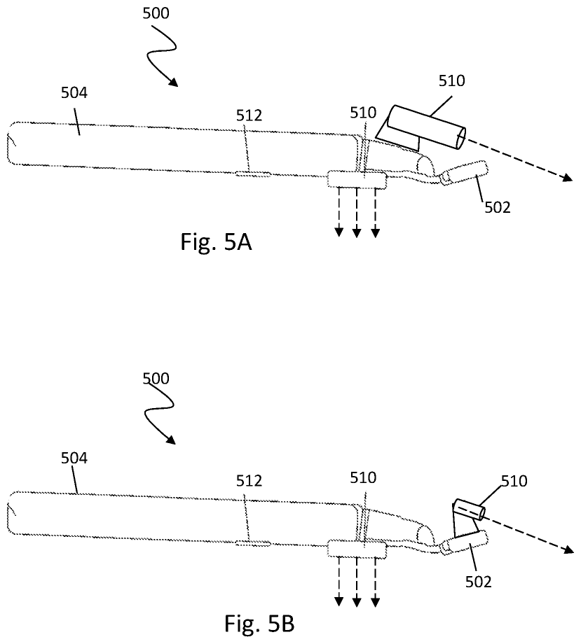

FIG. 5A illustrate a side view of a UV shaving device 500 with a blade cartridge 502 coupled to a handle 504 that includes a plurality of UV emitters 510 and a power switch 512. As shown, there is a UV emitter 510 on the bottom of the handle 504 and a UV emitter 510 on the top of the handle 504, which is directed down to illuminate the skin during shaving. The dashed arrows show the UV light illumination directions.

FIG. 5B illustrate a side view of another embodiment of a UV shaving device 500 with a blade cartridge 502 coupled to a handle 504 that includes a UV emitter 510 and a power switch 512. As shown, there is also a UV emitter 510 on the blade cartridge 502, which is directed down to illuminate the skin during shaving. The dashed arrows show the UV light illumination directions.

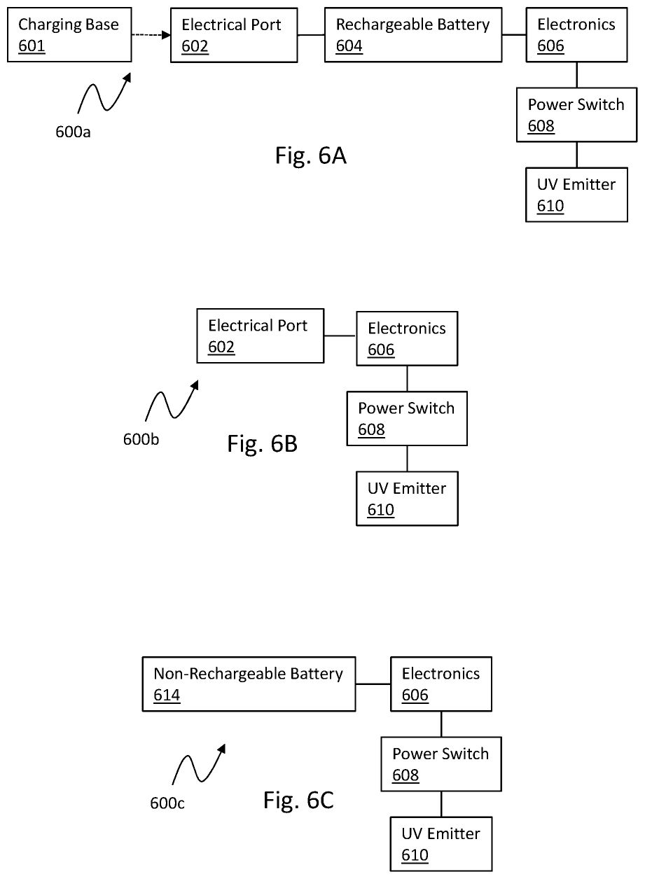

FIG. 6A illustrates a schematic representation of the electronic configuration of the UV shaving system 600a. The UV shaving system 600a is shown to include a charging base 601, which can be any suitable electrical charging station that can charge a rechargeable battery. The charging base 601 can be electronically coupled with the electrical port 602 of the UV shaving device. The electrical port 602 can provide electricity to charge the rechargeable battery 604. The rechargeable battery 604 is used for providing electricity to the electronics 606 of the UV shaving device, which can be controlled by a power switch 608. When the power switch 608 is on, the electronics 606 provide electricity to the UV emitter 610, which emits the UV light. When the power switch 608 is off, the electronics 606 do not provide electricity to the UV emitter 610. This allows the UV shaving device to be used in two different modes: (1) UV illuminating; and (2) no illumination.

FIG. 6B illustrates a schematic representation of the electronic configuration of the UV shaving system 600b. The UV shaving system 600b is shown to include an electrical port 602 of the UV shaving device that is configured to receive input electricity, such as from a standard wall outlet. The electrical port 602 can provide electricity to the electronics 606 of the UV shaving device, which can be controlled by a power switch 608. When the power switch 608 is on, the electronics 606 provide electricity to the UV emitter 610, which emits the UV light. When the power switch 608 is off, the electronics 606 do not provide electricity to the UV emitter 610. This allows the UV shaving device to be used in two different modes: (1) UV illuminating; and (2) no illumination. This embodiment is a corded version that uses an electrical cord to obtain electricity from the wall power outlet for operation.

FIG. 6C illustrates a schematic representation of the electronic configuration of the UV shaving system 600c. The UV shaving system 600c is shown to a non-rechargeable battery 614. The non-rechargeable battery 614 is used for providing electricity to the electronics 606 of the UV shaving device, which can be controlled by a power switch 608. When the power switch 608 is on, the electronics 606 provide electricity to the UV emitter 610, which emits the UV light. When the power switch 608 is off, the electronics 606 do not provide electricity to the UV emitter 610. This allows the UV shaving device to be used in two different modes: (1) UV illuminating; and (2) no illumination. This embodiment is not a corded version, and instead includes a lid that ca be opened to exchange batteries once the non-rechargeable battery 614 need to be replaced.

In some embodiments, the UV shaving system can use an electronics configuration of a combination of two or more of the embodiments of FIGS. 6A-6C.

In some embodiments, an ultraviolet (UV) shaving device can include a shaving device having at least one shaver configured for shaving hair and at least one UV light emitter located on the shaving device and positioned to emit UV light therefrom. The shaving device can be an electric shaving device. The shaving device can include a razor cartridge having at least one razor, wherein the razor cartridge is configured to be removably couplable with a handle. The shaving device can be a straight razor having a blade pivotally coupled with a handle.

In some embodiments, there can be at least one UV emitter included on a handle of the shaving device. The at least one UV emitter is operably coupled with a power switch. In some aspects, at least a first UV emitter is located on a skin facing surface, wherein the skin facing surface faces skin when the shaving device is used for shaving. In some aspects, the UV shaving device can include a battery operably coupled with the power switch. In some aspects, the battery is a rechargeable battery and the shaving device further includes an electrical port operably coupled with the rechargeable battery and being configured for recharging the rechargeable battery.

In some embodiments, the UV shaving device can include a magnetic coupling system having a first magnetic component on the handle and a second magnetic component on the razor cartridge. Accordingly, one of the first or second magnetic component is a magnet and the other is a magnetically-responsive material. The magnetically-responsive material can be another magnet (e.g., opposite pole facing the first magnet) or an iron material or an iron alloy (e.g., steel).

In some embodiments, a fluorescent shaving cream can include a shaving cream composition and a fluorescent substance in the shaving cream composition. The fluorescent substance can include a bonding agent that preferentially bonds with hair over skin. However, no specific bonding agent is needed as the fluorescent substance can be configured for binding to the hair. In some embodiments, the bonding agent includes a cationic moiety that electrostatically bonds with negatively charged hair. In some aspects, the shaving cream composition includes one or more of a soaping agent, a surfactant, an emulsifier, an emollient, a solvent, water, or combinations thereof.

In some embodiments, an UV shaving system can include a fluorescent shaving cream including a fluorescent substance and a shaving device including at least one UV light emitter. In some aspects, the shaving device is one of: an electric shaving device; a manual the shaving device that includes a razor cartridge having at least one razor, wherein the razor cartridge is configured to be removably couplable with a handle; or a straight razor having a blade pivotally coupled with a handle. In some aspects, there is at least one UV emitter included on a handle of the shaving device, wherein the at least one UV emitter is operably coupled with a power switch. In some aspects, the fluorescent substance includes a bonding agent that preferentially bonds with hair over skin. The fluorescent shaving cream and shaving device can be configured as described herein.

In some embodiments, a method of shaving can include: applying a fluorescent shaving cream to an area of skin having hair; illuminating the fluorescent shaving cream with an ultraviolet (UV) light; and shaving the hair from the area of skin with a shaving device under illumination from the UV light. In some aspects, the shaving device includes an UV emitter that emits the UV light. In other aspects, the shaving device omits the UV emitter, and there is an external UV light that is used to illuminate the fluorescent substance to make it glow fluorescently.

An example formulation is provided in the table below. The percentage of each component (w/w) can vary, such as from 1% to 25%, 5% to 20%, or 10%-15% by weight percent.

| Ingredient | % (W/W) |
|---|---|
| Water | 73.29520% |
| Behentrimonium Methosulfate | 3.15000% |
| Cetyl Alcohol | 2.40000% |
| Butylene Glycol | 0.45000% |
| Pigment Powder | 0.60000% |
| Polyglyceryl-3 Distearate | 0.52485% |
| Polysorbate 60 | 0.22485% |
| Myristic Acid | 0.08985% |
| Palmitic Acid | 0.08985% |
| Stearic Acid | 0.08985% |
| Guar Hydroxypropyltrimoniun Chloride | 0.08985% |
| Triticum Vulgare (Wheat) Flour Lipid | 0.01635% |
| Persea Gratissima (Avocado) Oil | 0.01635% |
| Quaternium 91 | 0.94500% |
| Cetrimonium Methosulfate | 0.42000% |
| Stearalkonium Chloride | 1.83750% |
| Ethanol | 0.26250% |
| Glycerin | 2.00000% |
| Betaine | 2.00000% |
| Hydroxypropyl Bis- | 1.40000% |
| Hydroxyethyldimonium Chloride | |
| Stearyl Alcohol | 2.00000% |
| Cetearyl Alcohol | 2.00000% |
| Phenoxyethanol | 0.76800% |
| Caprylyl Glycol | 0.24000% |
| Chlorphenesin | 0.19200% |
| Vitis Vinifera (Grape) Seed Oil | 1.00000% |
| Dimethicone | 1.00000% |
| Cocos Nucifera (Coconut) Oil | 1.00000% |
| Fragrance | 0.60000% |
| Hydroxyethylcellulose | 0.50000% |
| Butyrospermum Parkii (Shea) Butter | 0.50000% |
| PEG-90M | 0.20000% |
| Tetrasodium Glutamate Diacetate | 0.04800% |
| Tocopherol | 0.05000% |

In accordance with common practice, the various features illustrated in the drawings may not be drawn to scale. The illustrations presented in the present disclosure are not meant to be actual views of any particular apparatus (e.g., device, system, etc.) or method, but are merely example representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

One skilled in the art will appreciate that, for the processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. An ultraviolet (UV) shaving device comprising:
a shaving device having at least one shaver configured for shaving hair; and
at least one UV light emitter located on the shaving device and positioned to emit UV light therefrom.

2. The UV shaving device of claim 1, wherein the shaving device is an electric shaving device.

3. The UV shaving device of claim 1, wherein the shaving device includes a razor cartridge having at least one razor, wherein the razor cartridge is configured to be removably couplable with a handle.

4. The UV shaving device of claim 1, wherein the shaving device is a straight razor having a blade pivotally coupled with a handle.

5. The UV shaving device of claim 1, wherein the at least one UV emitter is included on a handle of the shaving device, wherein the at least one UV emitter is operably coupled with a power switch.

6. The UV shaving device of claim 5, wherein at least a first UV emitter is located on a skin facing surface, wherein the skin facing surface faces skin when the shaving device is used for shaving.

7. The UV shaving device of claim 6, further comprising a battery operably coupled with the power switch.

8. The UV shaving device of claim 7, wherein the battery is a rechargeable battery and the shaving device further comprises an electrical port operably coupled with the rechargeable battery and being configured for recharging the rechargeable battery.

9. The UV shaving device of claim 3, further comprising a magnetic coupling system having a first magnetic component on the handle and a second magnetic component on the razor cartridge, wherein one of the first or second magnetic component is a magnet and the other is a magnetically-responsive material.

10. A fluorescent shaving cream comprising:
a shaving cream composition; and
a fluorescent substance in the shaving cream composition.

11. The fluorescent shaving cream of claim 10, wherein the fluorescent substance includes a bonding agent that preferentially bonds with hair over skin.

12. The fluorescent shaving cream of claim 10, wherein the bonding agent includes a cationic moiety.

13. The fluorescent shaving cream of claim 10, wherein the shaving cream composition includes one or more of a soaping agent, a surfactant, an emulsifier, an emollient, a solvent, water, or combinations thereof.

14. An ultraviolet (UV) shaving system comprising:
a fluorescent shaving cream including a fluorescent substance; and
a shaving device including at least one UV light emitter.

15. The UV shaving system of claim 14, wherein the shaving device is one of:
an electric shaving device;
a manual the shaving device that includes a razor cartridge having at least one razor, wherein the razor cartridge is configured to be removably couplable with a handle; or
a straight razor having a blade pivotally coupled with a handle.

16. The UV shaving system of claim 14, wherein the at least one UV emitter is included on a handle of the shaving device, wherein the at least one UV emitter is operably coupled with a power switch.

17. The UV shaving system of claim 14, wherein the fluorescent substance includes a bonding agent that preferentially bonds with hair over skin.

18. The UV shaving system of claim 14, wherein the shaving cream composition includes one or more of a soaping agent, a surfactant, an emulsifier, an emollient, a solvent, water, or combinations thereof.

19. A method of shaving comprising:
applying a fluorescent shaving cream to an area of skin having hair;
illuminating the fluorescent shaving cream with an ultraviolet (UV) light; and
shaving the hair from the area of skin with a shaving device under illumination from the UV light.

20. The method of claim 19, wherein the shaving device includes an UV emitter that emits the UV light.
